(19) United States
(12) Patent Application Publication
(10) Pub. No.: US 2015/0113399 A1
(43) Pub. Date: Apr. 23, 2015

(54) Landing Page for Presenting Media Items

(71) Applicant: Google Inc., Mountain View, CA (US)

(72) Inventors: Brandon Bilinski, San Francisco, CA (US); Cyrus Phiroze Master, Ogden, UT (US); Curtis Glenn Hawthorne, Mountain View, CA (US)

(73) Assignee: Google Inc., Mountain View, CA (US)

(21) Appl. No.: 14/059,550

(22) Filed: Oct. 22, 2013

(51) Int. Cl. G06F 3/0482

(52) U.S. Cl. CPC G06F 3/0482
USPC 715/716

(57) ABSTRACT

Methods and systems for generating a landing page for displaying a plurality of displayed media items are provided. A landing page may include a plurality of sections, and each displayed media item may be displayed in a separate section of the landing page. For a first section of the landing page, a first category may be selected from among a set of categories based on a display probability for the first category. Each category in the set of categories may have a display probability. A first displayed media item may be selected from among a first plurality of media items in the first category. For each section of the landing page, a category may be selected from among the set of categories based on a display probability for the each category, and a displayed media item may be selected from among a plurality of media items in the each category.

### BACKGROUND

In the world of large media libraries and media subscription services with millions of media items (e.g., songs, videos, movies, books, radio stations, playlists, and the like), it has become increasingly difficult for users to select and find media to access and/or activate. In addition to a user's media library, some services present media, such as recommended media, to users based on the media and/or genres previously activated by a user. Media available to a user may be organized by media categories such as a user's media library, recently activated media items, media recommendations, media stations, and the like. Although media may be organized by category, in order for a user to discover and/or activate a media item in a media category, the user may have to browse each media category to select a media item they wish to activate. This process of finding and selecting a media item from within several different categories of media can be time consuming and onerous.

### BRIEF SUMMARY

According to an embodiment of the disclosed subject matter, a method includes generating a landing page for displaying a plurality of displayed media items. Each displayed media item may be displayed in a separate section of the landing page. For a first section of the landing page, a first category may be selected from among a set of categories based on a display probability for the first category, and each category in the set of categories may have a display probability. Next, a first displayed media item may be selected from among a first plurality of media items in the first category.

An implementation according to the disclosed subject matter provides a system including a processor configured to generate a landing page for displaying a plurality of displayed media items, and each displayed media item may be displayed in a separate section of the landing page. For a first section of the landing page, a first category may be selected from among a set of categories based on a display probability for the first category. Each category in the set of categories may have a display probability. Next, a first displayed media item may be selected from among a first plurality of media items in the first category.

Implementations of the disclosed subject matter provide a landing page for presenting media items to a user. The disclosed system may generate interest by a user by presenting multiple media items from different categories of media, allowing a user to find and select media items to activate simply by visiting his unique landing page. Additionally, because the probability that a particular media category will be assigned to a portion of the landing page may continuously change, a dynamic and unique landing page may be created for each user. This may result in improved ability to find and select media items in various media categories, as well as increased user satisfaction. Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process according to an implementation of the disclosed subject matter.

FIG. 2 shows a display interface according to an implementation of the disclosed subject matter.

FIG. 3 shows a computer according to an embodiment of the disclosed subject matter.

FIG. 4 shows a network configuration according to an embodiment of the disclosed subject matter.

### DETAILED DESCRIPTION

Existing media service providers generally provide users with various categories of media, such as “recently played”, “purchased”, “new albums”, “new titles”, “shared playlists”, “new releases”, “recent radio stations”, “recommended media”, and the like. Media service providers may present various categories of media to a user in a way that requires the user to explore each category of media to find and select a media item from among the media items in each media category.

The present disclosure provides a modular, dynamic landing page for presenting media to a user. The landing page may display multiple categories of media to a user based on a display probability for each category of media. In particular, the landing page may include separate sections, and for each section, a category of media may be selected based on the display probability for the media category. From within the selected category of media, a media item may be selected from among the media items in the media category and this selected media item may be displayed in a section of the landing page. The display probability of each media category may be based on a variety of factors such as a user setting, a default system setting, a user's activation history of media in a media category, a user's landing page behavior associated with a media category, and the like. In some cases, the display probability for each media category may continuously change. As a result, the landing page may present media items to a user in a dynamic way, allowing a user to find and select media items from multiple media categories by only visiting his unique landing page. The landing page according to the present disclosure provides a landing page for presenting and blending multiple categories of media items while providing randomness and generating interest by a user.

A landing page may be divided into sections and each section may display a media item. A displayed media item may be a media item from a selected media category that is displayed in a section of a landing page. A media category may be selected, for each section, from among multiple media categories based on a display probability for each media category. For example, for a landing page having 16 sections (each section displaying a media item), there may be five media categories of media items: recent albums, recent radio, new releases, suggested radio, and shared playlists. Each media category may have a predetermined display probability which determines the likelihood that a media category may be selected for a section of the landing page. The percentages may be set as follows: recent albums—60%, recent radio —10%, suggested radio—10%, new releases—10%, and shared playlists—10%. Each media category may include a list of media items, which may be sorted chronologically, ranked by relevancy, or unranked (e.g., the suggested radio category). The display probability for each category may be set by a user, set by a media provider, a default setting, or randomly set. Based on the media category selected for a section of the landing page, a media item from the media category may be displayed in the section of the landing page. This technique may be repeated for each section of the landing page, thereby providing a landing page displaying multiple media items, each in a different section of the landing page. Every time a user starts a new landing page session, such as on the web or a device, the landing page may be refreshed, and each section may be reassigned a media category and may display a media item.

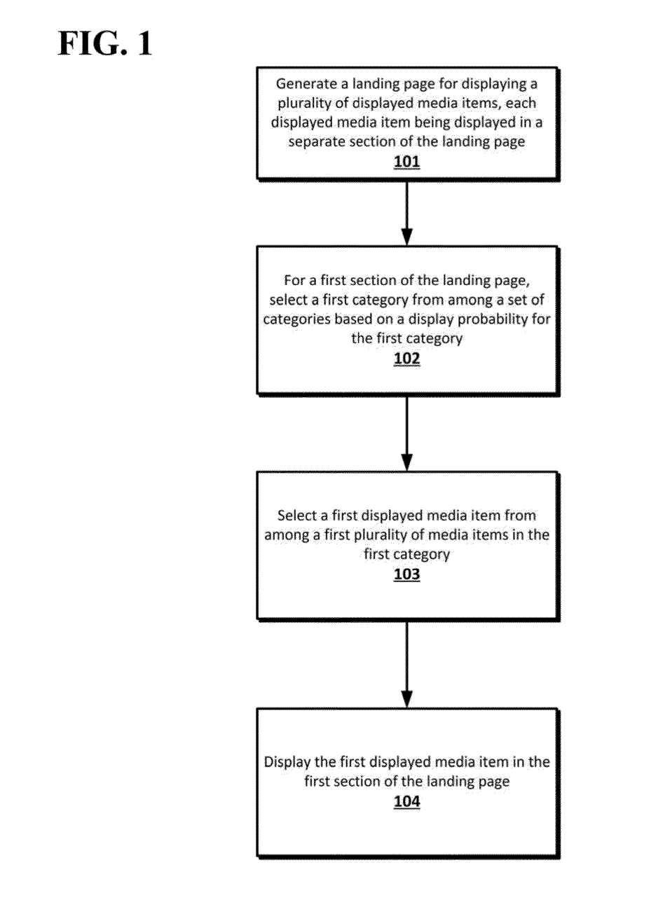

Implementations of the disclosed subject matter provide methods and systems for providing a landing page for displaying media items. FIG. 1 shows an example process according to an implementation of the disclosed subject matter. At 101, a method may include generating a landing page for displaying multiple displayed media items. Each displayed media item may be displayed in a separate section of the landing page, at 101. For a first section of the landing page, a first media category may be selected from among a set of media categories based on a display probability for the first category, at 102. Each category in the set of categories may have a display probability. Next, a first displayed media item may be selected from among a first plurality of media items in the first category, at 103. As a result, the first displayed media item may be displayed in the first section of the landing page, at 104.

The process shown in FIG. 1 may be performed for each section of a landing page. For example, the process above may further comprise, for a second section of the landing page, selecting a second category from among the set of categories based on a display probability for the second category. Next, a second displayed media item may be displayed from among a second plurality of media items in the second category.

A media item may be any media item that may be activated by a user. For example, a media item may be a song, a video, a movie, a show, a book, a magazine, a newspaper, an e-book, an album, a playlist, a radio station, a media content channel, a webpage, and the like. Activating a media item may be any action associated with a media item such as playing, displaying, presenting, listening, reviewing, rating, machine speaking, previewing, purchasing, owning, viewing, providing social media input associated with a media item, and the like.

A category of media items may be any category used to organize multiple media items, each media item in a media category having a common attribute. For example, each of the media items in the recently added albums media category may be an album that was recently added to a user's media library. There may be an unlimited number of media categories. Some examples of media categories may be recently played media items, recently added albums, recently purchased media items, recently activated playlists, recently followed playlists, recently played radio stations, recommended media items, recommended new releases, and the like.

Each media category may include a multiple media items, from among which a media item may be selected to be displayed in a section of a landing page. As an example, a recently viewed movies category may include all of the movies a user has viewed in the last 6 months, which may be 50 movies. When the recently viewed movies category is selected for a section of a landing page, 1 of the 50 recently viewed movies may be randomly selected to be displayed in the section. Additionally, the media items in a media category may be organized in a list. In an implementation, each of the first plurality of media items in the first category may be ranked in a list based on the last time the media item was activated by a user. For example, the list of recently viewed movies may be organized according to how recently each movie in the list was activated by the user, such that the most recently viewed movie is the first in the list and so on. In this case, as in the example above, when the recently viewed movies category is selected for a section of a landing page, the first movie in the list of the 50 recently viewed movies may be selected to be displayed in the section.

For some media categories, the media items included in the category and/or the order of the media items in the category may continuously change and update based on various factors. For example, the media items and/or the order of media items in a category may change based on a user's media activation history. In particular, media items may be added to or deleted from a media category based on a user's media activation history. A user's media activation history may include data taken from, for example, a user's media library, a user's media viewing history, a user's media listen history from a media service provider, a user's media purchase history, a user's media preview history, a user's social media input associated with a media item, a user's review/rating history associated with a media item, and any other similar data indicating a user's preference for media items and/or categories of media. For example, if a user recently previewed the book Sea Salt, the media category of recently previewed books may be updated to include the book Sea Salt. Additionally, the books in the recently previewed books categories may be included in a list, such that the first book in the list is the book that was most recently previewed by the user, for example, Sea Salt. Accordingly, for a first section of the landing page, if the recently previewed books category is selected, the book Sea Salt may be displayed in the first section of the landing page.

In addition, media categories associated with recommended media items may be based on a user's media activation history and these recommended media categories may update according to a user's changing media activation history. In connection with the example above, if a user recently previewed the book Sea Salt, the media category of recommended books may be updated to include books similar to the book Sea Salt, books by the same author of Sea Salt, books of the same genre as Sea Salt, and the like. The order of media items in a recommended media item category may also change and update according to a user's changing media activation history. For example, the first recommended book in the list of recommended books category may be the book Nights by the Sea, a book similar to Sea Salt, based on the user's most recent preview of the book Sea Salt. As a result, for a first section of the landing page, if the recommended books category is selected, the book Nights by the Sea may be displayed in the first section of the landing page.

A displayed media item may be a media item that is displayed in a section of a landing page. A media item may be displayed in a section of a landing page in a variety of ways. Displaying a media item may include displaying content associated with a media item. Content associated with a media item may be an image, a graphic, an icon, a link, an action item, a clip, and the like. For example, a section of a landing page may display a song by presenting an image associated with the song, the album cover associated with the song, album artwork associated with the song, an image of the artist of the song, an option to play an audio clip of the song, and the like. As another example, a section of a landing page may display a game by presenting an icon associated with the game, a link to purchase the game, an action item associated with the game such as an option to add the game to the user's cart or wish list, and the like. An action item may also include an option to activate a media item such as play or view the media item.

A display probability may be represented according to any probability format such as a percentage, a ratio, a fraction, and the like. According to an implementation, a display probability may be a percentage within the range of 0% to 100%. As mentioned above, a display probability for a media category may be based on a variety of factors such as one or more media preferences for a user, a landing page behavior history for a user, a media activation history for a user, a user setting, a media provider setting, a default system setting, and the like. For example, a user setting may allow a user to designate a display probability for each media category among multiple media categories. A user may prefer to see more media items from a particular media category; as such the user may set a higher display probability (e.g., 60%) for that media category. The user may not wish to see any media items from a particular media category, such as recommended radio stations, accordingly the user may set the display probability for this category to 0%, such as by disabling display of that category via a user preferences interface or the like. Additionally, a system setting or a media provider may designate a default display probability for each media category within a set of media categories.

In some cases, the display probability for a media category may change. A display probability for a media category may change continuously based on a user's media activation history (described above), the user's landing page behavior, a user setting, a system setting, and the like. For example, if a user has recently activated several media items in a new release media category, the display probability may increase for the new release media category. This may result in an increase in the number of displayed media items from the new release category in more sections of the landing page. A user's landing page behavior may also change the display probability for a media category. A user's landing page behavior may be based on the user's activation of displayed media items on a landing page. For example, if the user activates several displayed media items on the landing page from a particular media category, such as recommended radio stations from the recommended radio station media category, the display probability for the recommended radio station media category may be increased. Similarly, if a user never activates displayed media items from the recommended games category, the display probability for the recommended games category may be lowered. As another example, a user setting and/or system setting may cause a display probability to change for a media category at certain times, such as every time a landing page is generated, every week, every month, and the like. For example, a user may wish for the display probability for each media category in a set of media categories to be randomly changed each time a landing page is generated for him.

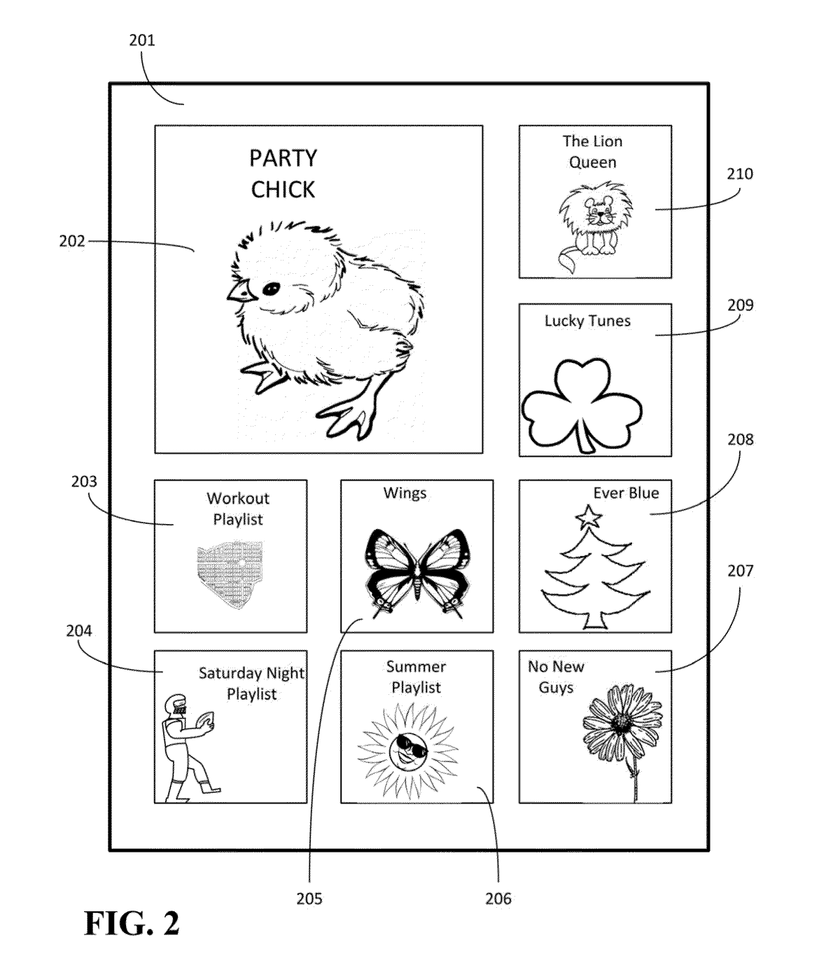

FIG. 2 shows a display interface according to an implementation of the disclosed subject matter. An implementation of the disclosed subject matter includes a system comprising a processor configured to generate a landing page 201 for displaying multiple displayed media items 202, 203, 204, 205, 206, 207, 208, 209, 210. Each displayed media item 202, 203, 204, 205, 206, 207, 208, 209, 210 may be displayed in a separate section of the landing page 201. For a first section of the landing page at 202, a first category may be selected from among a set of categories based on a display probability for the first category. Each category in the set of categories may have a display probability. Next, a first displayed media item 202 may be selected from among a first plurality of media items in the first category.

As shown in FIG. 2, a landing page 201 may have multiple sections 202, 203, 204, 205, 206, 207, 208, 209, 210, for displaying multiple displayed media items. There may be a set of media categories from among which a media category may be selected. Based on the selected media category, a displayed media item may be selected from among one more media items in the selected media category. For example, the set of media categories may include the following media categories, each media category having a display probability and a number of media items:

TABLE 1

| | Display | Number of |
|---|---|---|
| Category | Probability | Media Items |
| Recently Played/Purchased | 60% | 50 |
| Albums and Songs | | |
| Recently Played/Followed Playlists | 10% (3 max) | 5 |
| Recently Played Radio Stations | 10% | 2 |
| Recommended Radio Stations | 10% (5 max) | 8 |
| Recommended New Releases | 10% (5 max) | 25 |

In addition, particular categories, such as Recently Played/Followed Playlists, Recommended Radio Stations, and Recommended New Releases may have a limit as to the maximum number of media items from each of these media categories that may be displayed on the landing page 201. For each section 202, 203, 204, 205, 206, 207, 208, 209, 210 of the landing page 201, a media category may be selected from among the set of categories based on the display probability of each of the media categories. For example, as shown in Table 1, for each section 202, 203, 204, 205, 206, 207, 208, 209, 210 of the landing page 201 there is a 60% probability that the Recently Played/Purchased Albums category will be selected, a 10% probability that Recently Played/Followed Playlists category will be selected, a 10% probability that the Recently Played Radio Stations category will be selected, a 10% probability that the Recommended Radio Stations category will be selected, and a 10% probability that the Recommended New Releases category will be selected. If a media category is selected for a section of the landing page 201, a media item in the selected media category may be a displayed media item in that section of the landing page 201. Each media category may include multiple media items. As shown in Table 1 above, there may be 50 media items (e.g., 50 albums/songs) in the Recently Played/Purchased Albums and Songs category, 5 media items (e.g., 5 playlists) in the Recently Played/Followed Playlists category, 2 media items (e.g., 2 radio stations) in the Recently Played Radio Stations category, 8 media items (e.g., 8 radio stations) in the Recommended Radio Stations category, and 25 media items (e.g., 25 new releases, such as songs/albums) in the Recommended New Releases category.

According to an implementation, for each section 202, 203, 204, 205, 206, 207, 208, 209, 210 of the landing page, a media category may be selected from among a set of media categories based on the display probability of each media category. For each section 202, 203, 204, 205, 206, 207, 208, 209, 210, a media category may be selected from among the set of media categories independently from which media category may have been selected for other sections of the landing page. In particular, each of section 202, 203, 204, 205, 206, 207, 208, 209, 210 of the landing page has the same likelihood of selecting one out of the 5 media categories, i.e., a 60% probability of selecting the Recently Played/Purchased Albums category, a 10% probability of selecting the Recently Played/Followed Playlists category, a 10% probability of selecting the Recently Played Radio Stations category, a 10% probability of selecting the Recommended Radio Stations category, and a 10% probability of selecting the Recommended New Releases category.

As shown in FIG. 2, for a first section 202, a media category may be selected from among the 5 media categories Recently Played/Purchased Albums and Songs, Recently Played/Followed Playlists, Recently Played Radio Stations, and Recommended Radio Stations. The media category Recommended New Releases may be selected based on the 10% display probability. As a result, a media item from among the 25 media items in the Recommended New Releases category may be selected. A media item may be randomly selected from among the 25 media items. Alternatively, the 25 media items may be ranked in a list based on how recently the media item was added to the Recommended New Releases category, such that the most recently added media item is first in the list. In this case, the first media item listed in the Recommended New Releases category may be displayed at section 202. As shown, the recommended new release song Party Chick may be displayed in section 202 of the landing page 201.

As another example, for section 210, the media category Recently Played/Purchased Albums and Songs may be selected based on the 60% display probability. Accordingly, a media item from the Recently Played/Purchased Albums and Songs category may be selected. As mentioned in Table 1 above, there may be 50 albums/songs in the Recently Played/Purchased Albums and Songs category. As shown at 210, the album No New Guys may be selected from among the 50 albums/songs in the category, and may be displayed. As mentioned above, displaying a media item may include displaying content associated with a media item. As shown at 210, the album No New Guys may be displayed by displaying the album artwork and may also include an action item to begin playing the album.

In some cases, the selected first category and selected second category may be the same. For example, the Recently Played/Followed Playlists category may be selected for section 203 of the landing page. As a result, a first playlist, such as the Workout Playlist, may be randomly selected from among the 5 playlists in the Recently Played/Followed Playlists category and may be displayed in section 203. The Recently Played/Followed Playlists category may be selected again for section 204 of the landing page. Accordingly, a second playlist, such as the Saturday Night Playlist, may be randomly selected from among the 4 remaining playlists (not including the previously displayed Workout Playlist) in the Recently Played/Followed Playlists category and may be displayed in section 204. Again, the Recently Played/Followed Playlists category may be selected for section 206, and a third playlist, such as the Summer Playlist, may be randomly selected from among the remaining 3 playlists (not including the previously displayed Workout Playlist and Saturday Night Playlist) and may be displayed in section 206.

As mentioned above, media items in a media category may be ranked in a list based on recency, such as how recently the media item was added to the media category, such that the most recently added media item is the first media item in the list and so on. According to an implementation, for a third section of the landing page, the first category may be selected from among the set of categories based on the display probability for the first category. As a result, a third displayed media item may be selected from among the first plurality of media items in the first category, such that the third displayed media item is listed after the first displayed media item in the list of the first plurality of media items. In connection with the example above, if the Recently Played/Followed Playlists category is selected for section 203 of the landing page, the first playlist (e.g., Workout Playlist) in the list of playlists in the Recently Played/Followed Playlists category may be displayed in the section. If the Recently Played/Followed Playlists category is selected again for another section 204 of the landing page, the second playlist (e.g., Saturday Night Playlist) in the list of playlists in this category may be displayed in the other section. In this scenario, a category may be selected more than once and for each subsequent selection of the category, the subsequently displayed media item may be after the preceding displayed media item in the list of media items in the category.

In some scenarios, selection of a particular media category for a section may not result in a media item from that selected category being displayed in that section. According to an implementation, for a second section of the landing page, the first media category may be selected from among the set of media categories based on the display probability for the first media category. It may be determined that each of the media items in the first plurality of media items in the first media category has been previously displayed. Responsive to the determination that each of the media items in the first plurality of media items has been previously displayed, a second media category may be selected from among the set of media categories. Accordingly, a second displayed media item may be selected from among a second plurality of media items in the second category. For example, as shown in Table 1, the Recently Played Radio Stations category may include 2 media items, such as the recently played radio stations Wings and Lucky Tunes. As shown in FIG. 2, the Recently Played Radio Stations category may be selected for section 205. As a result, the recently played radio station Wings may be selected from among the 2 recently played radio stations in the category and Wings may be displayed in section 205. Next, the Recently Played Radio Stations category may be selected for section 209. As a result, the remaining recently played radio station Lucky Tunes may be displayed in section 209. For another section 208, the Recently Played Radio Stations category may be selected. However, because all of the media items (i.e., the 2 recently played radio stations Wings and Lucky Tunes) in the Recently Played Radio Stations category have been previously displayed in sections 205 and 209, another category may be selected for section 208. A second category, New Releases, may be selected for section 208, and as a result, a new release song Ever Blue may be selected from among the 25 media items in the New Release category and may be displayed in section 208. Thus, when all of the media items in a selected media category for a section have been previously displayed, another media category may be selected for the section.

In some instances, the number of displayed media items from a particular media category may be limited to a set maximum number of media items that may be displayed on a landing page. A maximum number of media items from a specific media category may be set by a user, a system setting, and the like. Similarly, a minimum number of displayed media items may be set for a particular media category. According to an implementation, the second category may be selected based on the number of times the first category was previously selected. As shown in Table 1, the Recently Played/Followed Playlists category may be limited to a maximum number of 3 media items, the Recommended Radio Stations category may be limited to a maximum number of 5 media items, and the Recommended New Releases category may be limited to a maximum number of 5 media items. In FIG. 2, for section 207, the Recently Played/Followed Playlists category may be selected based on the display probability of 10%. However, Recently Played/Followed Playlists category may have been previously selected for each of the sections 203, 204, and 206. Because the Recently Played/Followed Playlists category is limited to a maximum of 3 media items that may be displayed on the landing page, a second media category may be selected for section 207. Accordingly, for section 207, a second media category, Recently Played/Purchased Albums and Songs, may be selected based on the 60% display probability. As a result, the album The Lion Queen may be selected from among the 50 media items in the Recently Played/Purchased Albums and Songs category and may be displayed in section 207.

In some cases, the selection of the first category may be based on the number of times the first category was previously selected. Similarly, the category selected for a second position on a page may be based on the category selected for the first position. For example, a user may indicate that they do not wish to see more than one media item from a first media category. In this case, a first section of a landing page may display a media item from a first media category. For a second section of the landing page, the first media category may be selected; however, since one media item from the first category (i.e., the maximum set by the user) is displayed in the first section, a second media category may be selected. Accordingly, a media item from the second category may be displayed in the second section of the landing page.

According to an implementation, an entire landing page may be generated at once such that each section of a landing page displays a media item from a selected media category simultaneously. Alternatively, one or more sections of a landing page may update/change while one or more other sections may remain the same. Additionally, a landing page may be generated at various times, such as each time a landing page is refreshed, a user begins a new landing page session, a user opens a media application, and the like.

There may be various implementations for generating and/or providing a landing page to a user. A landing page may be provided in a web page, an online application, desktop, and/or mobile application (e.g., a media application), a document, and any other technique for providing a landing page to a user. A media provider may provide a landing page to a user or a media provider may provide a media application that includes a landing page feature. In an implementation, a landing page may be generated by any one or combination of entities such as a media provider, a media application provider, a landing page provider and the like. In some cases, each of a media provider, media application provider, and/or a landing page provider may be the same entity or each may be an entity independent of the other(s).

In an implementation, communication between a media provider, media application provider, and/or a landing page provider may be across one or more bridges between the interfaces. For example, the communications between the media provider, media application provider, and/or the landing page provider may be managed or assisted by a third device, such as, a coordinating device, a local coordinator, a remote server, etc. In such cases, the third device may, for example, select a first category from among a set of categories based on a display probability for the first category. The third device may then provide the selected first category to the media provider, in which case, the media provider may select a first displayed media item from among a first plurality of media items in the first category and provide the first displayed media item to the landing page provider and/or the media application provider. Alternatively, the third device may receive, from a media application, a selected first media category, and provide the selected first category to the media provider. The media provider may provide a first plurality of media items in the first category to the landing page provider and/or the media application provider. Accordingly, the landing page provider and/or the media application provider may select a first displayed media item from among the first plurality of media items in the first category, and display the first displayed media item in a section of a landing page. Furthermore, more than one intermediate device may be implemented to facilitate communication between a media provider, media application provider, and/or a landing page provider.

In situations in which the implementations of the disclosed subject matter collect personal information about users, or may make use of personal information, the users may be provided with an opportunity to control whether programs or features collect user information (e.g., a user's media viewing history, a user's media listen history from a media service provider, a user's media purchase history, a user's media preview history, a user's social media input associated with a media item, and any other similar data associated with a user), or to control whether and/or how to receive media items from the media provider that may be more relevant to the user. In addition, certain data may be treated in one or more ways before it is stored or used, so that personally identifiable information is removed. For example, a user's identity may be treated so that no personally identifiable information can be determined for the user, or a user's geographic location associated with a social network may be generalized where location information is obtained (such as to a city, ZIP code, or state level), so that a particular location of a user cannot be determined. Thus, the user may have control over how information is collected about the user and used by a media provider.

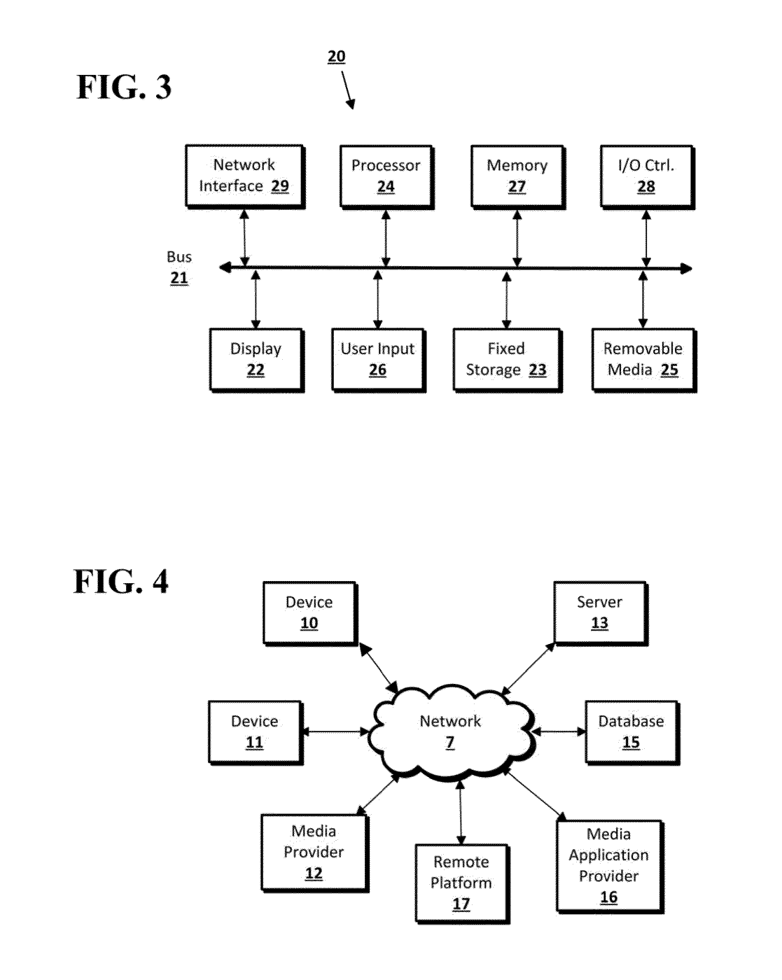

Embodiments of the presently disclosed subject matter may be implemented in and used with a variety of component and network architectures. FIG. 3 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras and so on). Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an embodiment of the disclosed subject matter. One or more clients 10, 11 such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more media provider 12, media application provider 16, servers 13 and/or databases 15. The devices may be directly accessible by the media provider 12, clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more media provider 12, media application provider 16, servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
generating a landing page for displaying a plurality of displayed media items, each displayed media item being displayed in a separate section of the landing page, wherein each displayed media item corresponds to a category from among a set of categories,
for a first section of the landing page, selecting a first category from among the set of categories based on a display probability for the first category, wherein each category in the set of categories has a display probability and wherein the display probability determines the likelihood that a category is selected from among the set of categories, and
selecting a first displayed media item from among a first plurality of media items in the first category.

2. The method of claim 1, further comprising, for a second section of the landing page, selecting a second category from among the set of categories based on a display probability for the second category, and
selecting a second displayed media item from among a second plurality of media items in the second category.

3. The method of claim 2, wherein selecting the second category from among the set of categories is further based on the selected first category.

4. The method of claim 2, wherein selecting the second category is further based on the number of times the first category was previously selected.

5. The method of claim 1, wherein the display probability is a percentage within the range of 0% to 100%.

6. The method of claim 1, wherein the display probability is set by a user.

7. The method of claim 1, wherein the display probability is set by a media provider.

8. The method of claim 1, wherein the display probability for each category in the set of categories is based on at least one selected from the group consisting of: one or more media preferences for a user, a landing page behavior history for a user, and a media activation history for a user.

9. The method of claim 1, wherein each of the first plurality of media items in the first category is ranked in a list based on the last time the media item was activated by a user.

10. The method of claim 9, further comprising, for a third section of the landing page, selecting the first category from among the set of categories based on the display probability for the first category, and
selecting a third displayed media item from among the first plurality of media items in the first category, wherein the third displayed media item is listed after the first displayed media item in the list of the first plurality of media items.

11. The method of claim 1, further comprising, for a second section of the landing page, selecting the first category from among the set of categories based on the display probability for the first category,
determining that each of the media items in the first plurality of media items in the first category has been previously displayed,
responsive to the determination that each of the media items in the first plurality of media items has been previously displayed, selecting a second category from among the set of categories, and
selecting a second displayed media item from among a second plurality of media items in the second category.

12. The method of claim 1, wherein the first displayed media item is selected from the group consisting of: a song, a video, a movie, a show, a book, a magazine, a newspaper, an e-book, an album, a media station, a playlist, a media subscription, and a media channel.

13. The method of claim 1, wherein the first category is selected from the group consisting of: recently played media items, recently viewed media items, recently purchased media items, recently activated media items, media stations, media channels, media subscriptions, media playlists, suggested media items, newly released media items, and a library of media items.

14. A system comprising:
a processor configured to:
generate a landing page for displaying a plurality of displayed media items, each displayed media item being displayed in a separate section of the landing page, wherein each displayed media item corresponds to a category from among a set of categories,
for a first section of the landing page, selecting a first category from among the set of categories based on a display probability for the first category, wherein each category in the set of categories has a display probability and wherein the display probability determines the likelihood that a category is selected from among the set of categories, and
select a first displayed media item from among a first plurality of media items in the first category.

15. The system of claim 14, wherein the landing page comprises a plurality of separate sections.

16. The system of claim 15, further comprising, for a second section of the landing page, selecting a second category from among the set of categories based on a display probability for the second category, and
selecting a second displayed media item from among a second plurality of media items in the second category.

17. The system of claim 16, wherein selecting the second category from among the set of categories is further based on the selected first category.

18. The system of claim 16, wherein selecting the second category is further based on the number of times the first category was previously selected.

19. The system of claim 14, wherein the display probability is a percentage within the range of 0% to 100%.

20. The system of claim 14, wherein the display probability is set by a user.

21. The system of claim 14, wherein the display probability is set by a media provider.

22. The system of claim 14, wherein the display probability for each category in the set of categories is based on at least one selected from the group consisting of: one or more media preferences for a user, a landing page behavior history for a user, and a media activation history for a user.

23. The system of claim 14, wherein each of the first plurality of media items in the first category is ranked in a list based on the last time the media item was activated by a user.

24. The system of claim 23, further comprising, for a third section of the landing page, selecting the first category from among the set of categories based on the display probability for the first category, and
selecting a third displayed media item from among the first plurality of media items in the first category, wherein the third displayed media item is listed after the first displayed media item in the list of the first plurality of media items.

25. The system of claim 14, further comprising, for a second section of the landing page, selecting the first category from among the set of categories based on the display probability for the first category,
determining that each of the media items in the first plurality of media items in the first category has been previously displayed
responsive to the determination that each of the media items has been previously displayed, selecting a second category from among the set of categories, and
selecting a second displayed media item from among a second plurality of media items in the second category.

26. The system of claim 14, wherein the first displayed media item is selected from the group consisting of: a song, a video, a movie, a show, a book, a magazine, a newspaper, an e-book, an album, a media station, a playlist, a media subscription, and a media channel.

27. The system of claim 14, wherein the first category is selected from the group consisting of: recently played media items, recently viewed media items, recently purchased media items, recently activated media items, media stations, media channels, media subscriptions, media playlists, suggested media items, newly released media items, and a library of media items.
